(19) United States
(12) Patent Application Publication
(10) Pub. No.: US 2019/0281913 A1
(43) Pub. Date: Sep. 19, 2019

(54) METHOD OF MANUFACTURING ARTIFICIAL EYELASHES

(71) Applicants: Chung Hyun ROH, Eunpyeong-gu Seoul (KR); M&C ELECTRONICS VINA COMPANY LIMITED, Bac Ninh Province (VN)

(72) Inventor: Chung Hyun ROH, Seoul (KR)

(21) Appl. No.: 16/347,566

(22) PCT Filed: Nov. 6, 2017
(86) PCT No.: PCT/KR2017/012469

§ 371 Date: May 3, 2019

(30) Foreign Application Priority Data
Nov. 4, 2016 (KR) 10-2016-0146401

(51) Int. Cl. A41G 5/02

(52) U.S. Cl. CPC A41G 5/02; B29C 2793/0081; B29C 2793/0054

(57) ABSTRACT

A method for manufacturing artificial eyelashes comprises the steps of: cutting a plastic sheet having a predetermined thickness and molding a plurality of strands and a base part, connected to one end of the plurality of strands to support the plurality of strands, into an integrally formed shape; bonding at least one strand of monofilaments across the plurality of strands to a portion of the plurality of strands adjacent to the base part; forming the artificial eyelashes by cutting and removing the side portion of the base part with respect to the portion bonded to the monofilaments in the shape; and winding the artificial eyelashes in the direction of arrangement of the plurality of strands as an axis so that the plurality of strands are curved.

### TECHNICAL FIELD

The present invention relates to artificial eyelashes, and more particularly, to a method of manufacturing artificial eyelashes.

### BACKGROUND

Generally, artificial eyelashes refer to eyelashes which are manufactured using artificial hair or human hair to be attached to real eyelashes or attached thereabove.

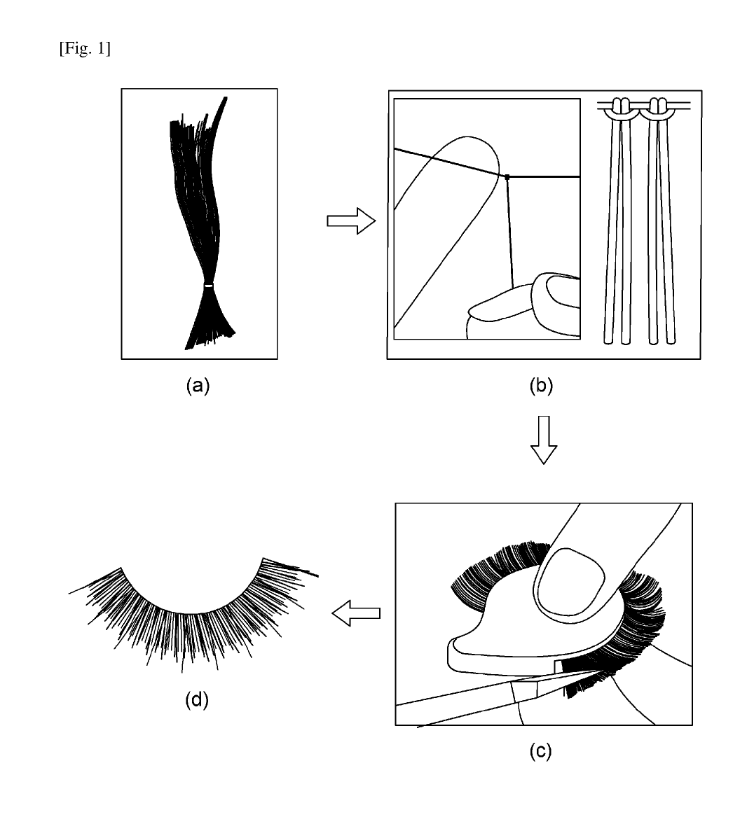

FIG. 1 is a view schematically illustrating an existing method of artificial eyelashes. First, strands of eyelashes, which are formed of artificial hair or human hair, are prepared (a), strands of eyelashes are fixed to a supporting thread by making knots one by one (b) and then are formed in a curved shape and processed in details (c), and artificial eyelashes are completed (d).

In the existing method of manufacturing artificial eyelashes, operation (b) and operation (c) are performed manually by a human such that a lot of working time is consumed and quality and productivity depend on only a skill level of a worker.

Accordingly, a method of manufacturing artificial eyelashes, capable of automating an entirety or a part of a manufacturing process, reducing a manufacturing time, and providing a consistent degree of quality is necessary.

### Technical Problem and Solution

The present invention is directed to providing a method of manufacturing artificial eyelashes, capable of automating an entirety or a part of a manufacturing process, reducing a manufacturing time, and providing a consistent degree of quality.

One aspect of the present invention provides a method of manufacturing artificial eyelashes. The method includes forming a shape, in which a plurality of strands and a base portion connected to one end of the plurality of strands to support the plurality of strands are integrally formed, by cutting the shape out of a plastic sheet having a certain thickness, adhering at least one monofilament to a part of the plurality of strands, which is adjacent to the base portion, across the plurality of strands, forming artificial eyelashes by cutting and removing the base portion's side from the shape on the basis of the part adhered to the monofilament, and bending the plurality of strands by rolling the artificial eyelashes around a direction in which the plurality of strands are arranged.

The method may further include polishing the plurality of strands.

The method may further include modifying the monofilament of the artificial eyelashes, of which the plurality of strands are bent, into an arc shape.

The method may further include applying an adhesive to the monofilament modified into the arc shape.

The forming of the shape may include cutting the plastic sheet using a laser cutter.

The laser cutter may use one of an ultraviolet (UV) laser, a CO2 laser, and a fiber laser.

A material of the plastic sheet may be one of polyethylene terephthalate (PET), polyethylene (PE), nylon, polyvinyl chloride (PVC), and polypropylene (PP).

The plurality of strands may have a width of 0.05 to 0.15 mm.

The forming of the shape may include cutting the plastic sheet using a press puncher.

### Advantageous Effects

According to the present invention, a plastic sheet having a certain thickness is cut into a shape, in which a plurality of strands and a base portion connected to one end of the plurality of strands to support the plurality of strands are integrally formed, a monofilament is adhered to the shape, and then the base portion is removed such that effects of automating an entirety or a part of a process of manufacturing artificial eyelashes, significantly reducing a manufacturing time, and providing artificial eyelashes having a consistent degree of quality are present.

### DETAILED DESCRIPTION OF THE DRAWINGS

FIG. 1 is a view schematically illustrating an existing method of artificial eyelashes.

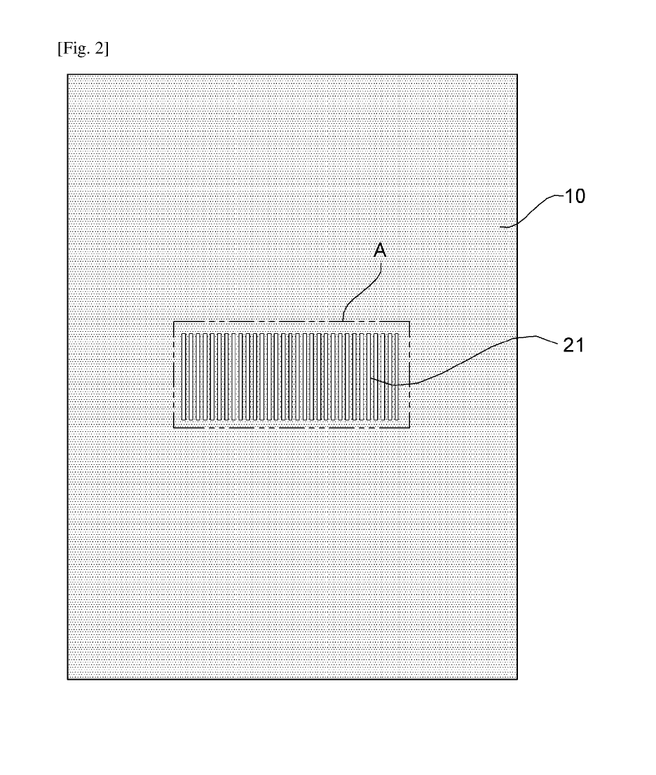

FIG. 2 illustrates a shape in which a plurality of strands are cut out of a certain inner area of a plastic sheet.

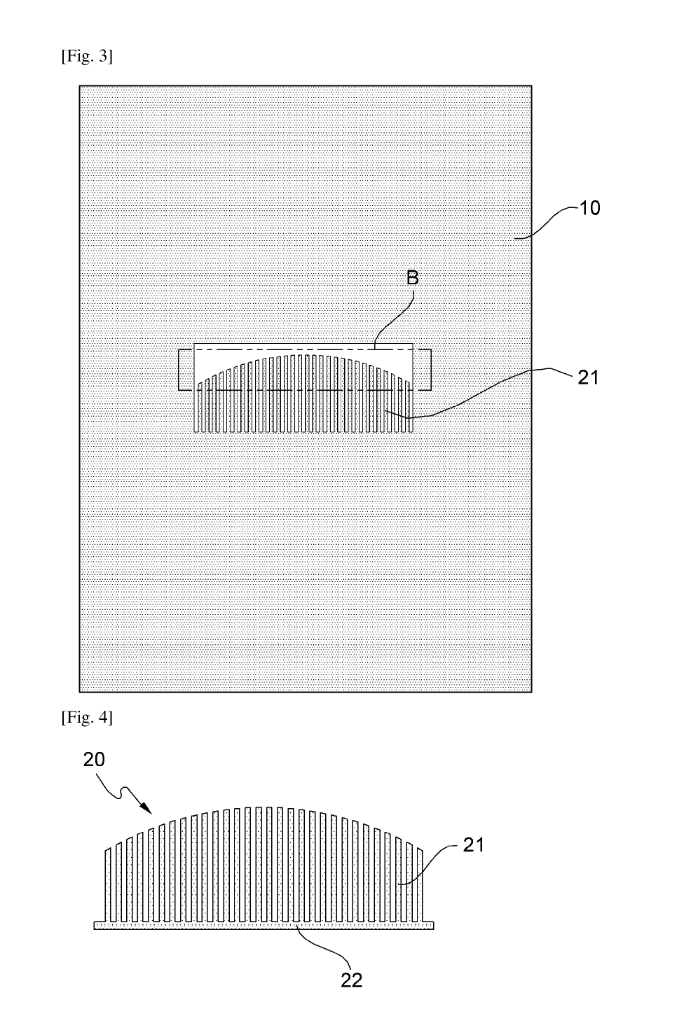

FIG. 3 illustrates a shape in which one side of the plurality of strands is cut to form an end line of eyelashes.

FIG. 4 illustrates a shape in which a plurality of strands and a base portion obtained by cutting the plastic sheet are integrally formed.

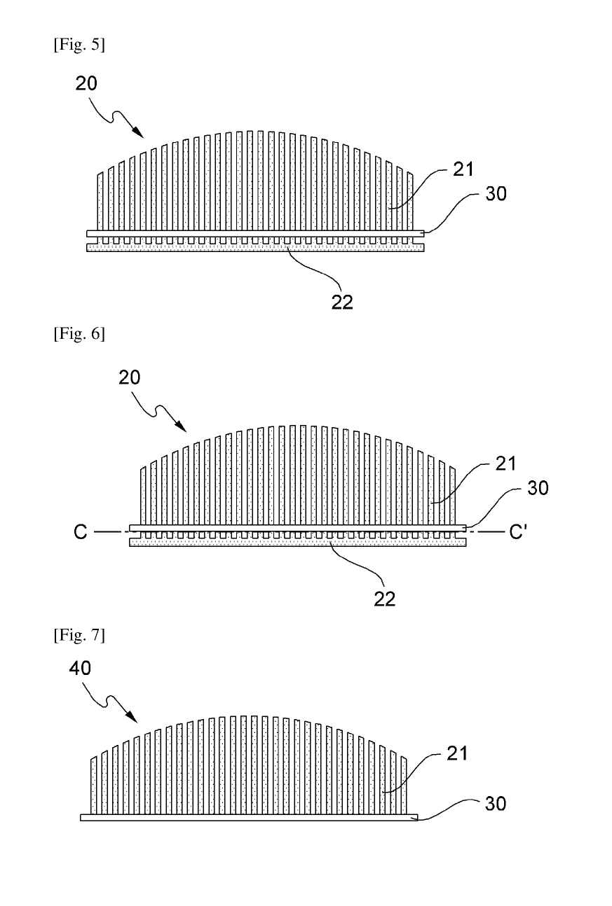

FIG. 5 illustrates a shape in which a monofilament is adhered to the shape of FIG. 4.

FIG. 6 illustrates a process in which a lower part of the monofilament is removed from the shown in FIG. 5.

FIG. 7 illustrates artificial eyelashes obtained according to an embodiment of the present invention.

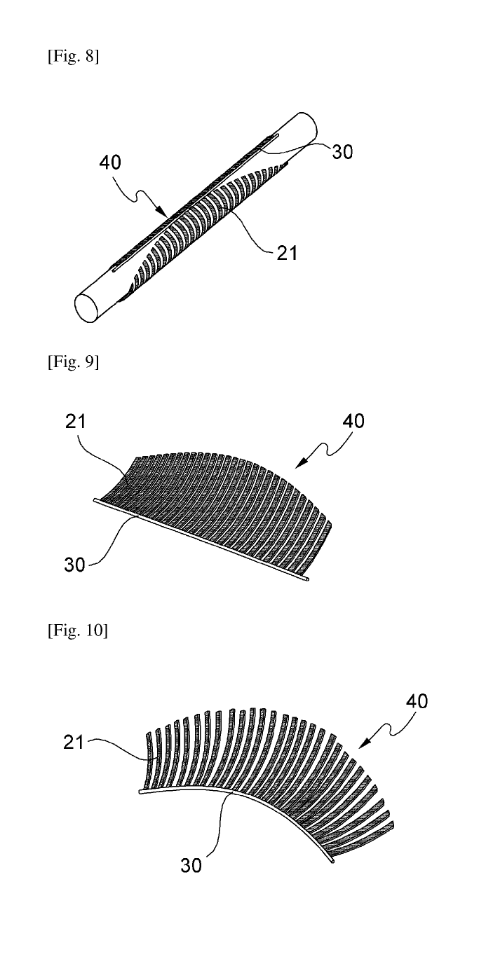

FIG. 8 illustrates a shape in which the artificial eyelashes of FIG. 7 are rolled around a direction in which the plurality of strands are arranged.

FIG. 9 illustrates a shape in which the plurality of strands are curled through the process of FIG. 8.

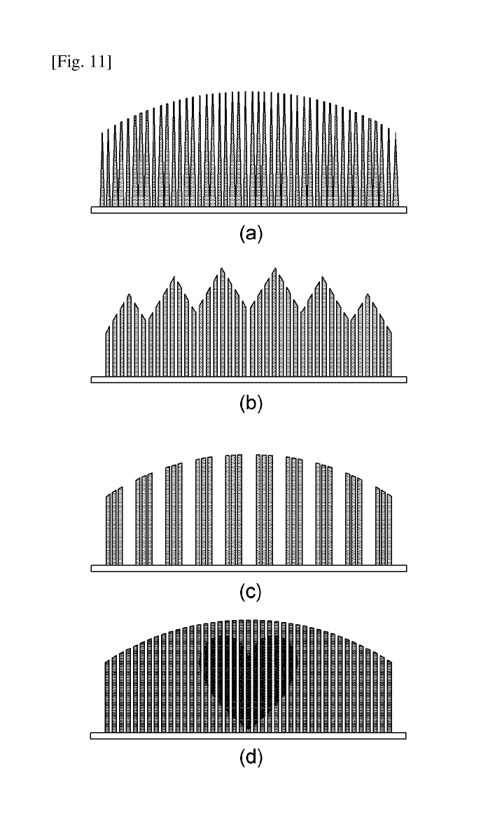

FIG. 10 illustrates a shape in which the monofilament of the artificial eyelashes of FIG. 9 is modified into an arc shape.

FIG. 11 illustrates artificial eyelashes according to a modified embodiment of FIG. 7.

### DETAILED DESCRIPTION

Hereinafter, exemplary embodiments of the present invention will be described in detail with reference to the attached drawings. In the following description and the attached drawings, substantially like elements are referred to as like reference numerals and an overlapping description will be omitted. Also, in the description of the present invention, a detailed description on well-known functions or components of the related art will be omitted when it is deemed to obscure the essence of the present invention.

FIGS. 2 to 10 are views illustrating a method of manufacturing artificial eyelashes according to one embodiment of the present invention.

According to the embodiment of the present invention, a plastic sheet 10 having a certain thickness is used as a material of strands of artificial eyelashes. As a material of the plastic sheet 10, for example, polyethylene terephthalate (PET), polyethylene (PE), nylon, polyvinyl chloride (PVC), polypropylene (PP), and the like may be used. In addition, eco-friendly materials such as protein and the like may be used. In consideration of throwing artificial eyelashes away after a short-term use, forming artificial eyelashes using eco-friendly materials such as protein and the like may contribute to solving environmental problems.

The plastic sheet 10 may have a thickness of about 0.05 to 0.15 mm and be black or a variety of other colors according to color of strands of eyelashes to be manufactured.

In the embodiment of the present invention, a shape 20, in which a plurality of strands 21 and a base portion 22 connected to one end of the plurality of strands 21 to support the plurality of strands 21 are integrally formed as shown in FIG. 4, is formed by cutting the plastic sheet 10.

The plastic sheet 10 may be cut using a laser cutter or a press puncher. In the case of a laser cutter, a laser cutter using an ultraviolet (UV) laser, a CO2 laser, a fiber laser, and the like may be used.

In the case of a UV laser cutter, capacity may be 5 to 10 W, velocity may be about 2 m/sec, and a laser width may be 10 to 25 μm.

In the case of a CO2 laser cutter, capacity may be 100 to 300 W, velocity may be about 2 m/sec, and a laser width may be 100 to 150 μm.

In the case of a fiber laser cutter, capacity may be 20 to 30 W, velocity may be about 2 m/sec, and a laser width may be 100 to 150 μm.

Among them, in the case of a UV laser, since heat does not occur at a section, deformation of a product is not present and a cut condition is relatively excellent. Also, due to a small laser width, it is most preferable to use a UV laser in the embodiment of the present invention.

In order to form the shape 20 as shown in FIG. 4 by cutting the plastic sheet 10, first, the plurality of strands 21 are cut out of a certain inner area A of the plastic sheet 10. Here, the plurality of strands 21 are strands of eyelashes, which form the artificial eyelashes, and a width and intervals thereof are determined according to the artificial eyelashes to be manufactured and may be generally 0.05 to 0.15 mm in order to provide effects of human hair. However, since the laser cutter or press puncher is used as described above, the width and intervals of the plurality of strands 21 may be modified to a desirable shape as necessary according to decorative and functional needs to be given to the artificial eyelashes as long as the laser cutter or press puncher supports.

Also, as shown in FIG. 3, eyelash-end line B is cut out of one side of the plurality of strands 21. Although it is shown as an example in FIG. 3 that the eyelash-end line B has a general arc shape, since the laser cutter or press puncher is used as described above, it is possible to form an eyelash-end line having a preferable shape as necessary according to decorative and functional needs to be given to the artificial eyelashes.

When only the plurality of strands 21 and the base portion 22 remain and other parts are removed by cutting the plastic sheet 10 in which the plurality of strands 21 and the eyelash-end line B are formed, the shape 20 in which the plurality of strands 21 and the base portion 22 connected to the one end of the plurality of strands 21 to support the plurality of strands 21 are integrally formed as shown in FIG. 4 is obtained. Here, a width of the base portion 22 may be about 0.5 to 2.0 mm. However, since the base portion 22 is a part to be removed as described below, the base portion 22 may have an arbitrary width adequate for being operated.

Also, in order to provide naturalness like real eyelashes, the plurality of strands 21 may be processed to have a rounded shape with a pointed end through a polishing process. Here, a coarse degree of the polishing process may be about #80 to #400.

In the embodiment of the present invention, it has been described that the eyelash-end line B is formed by cutting one side of the plurality of strands 21 as shown in FIG. 3 before the shape 20 in which the plurality of strands 21 and the base portion 22 are integrally formed is separated from the plastic sheet 10. On the other hand, the shape 20 in which the plurality of strands 21 and the base portion 22 are integrally formed is separated from the plastic sheet 10, and then the eyelash-end line B may be formed by cutting one side of the plurality of strands 21.

When the shape of FIG. 4 is obtained, a monofilament 30 is adhered to a part of the plurality of strands 21, which is adjacent to the base portion 22, across the plurality of strands 21. A length of the monofilament 30 corresponds to a length of the base portion 22, and a diameter thereof may be about 0.1 to 0.3 mm. One strand of the monofilament 30 may be adhered or several strands thereof may be adhered depending on a thickness to be formed. A material of the monofilament 30 may be PET, nylon, and the like, and color thereof may be black or transparent or may be a variety of other colors. A monofilament is generally used for a fishing line, a fishing net, and the like. However, in the embodiment of the present invention, the monofilament is used as a part of artificial eyelashes, which is attached to a human body. As described above, in the embodiment of the present invention, strands of artificial eyelashes are formed at one time using a plastic sheet. Here, the monofilament 30 is advantageous to being adhered to the plastic sheet. The plurality of strands 21 and the monofilament 30 may be adhered to each other using, for example, a polyurethane adhesive.

According to an embodiment, while two shapes, which include the plurality of strands and the base portion, overlap with each other, a monofilament may be adhered to the strands of the two shapes. Then, the strands of the two shapes are formed as two layers such that a three-dimensional effect for naturalness or aesthetics may be provided like real eyelashes. In this case, patterns of the strands of the two shapes (for example, a width, intervals, an array pattern, an extension direction, a shape, and the like) may differ from each other such that more various and unique designs may be provided.

As shown in FIG. 6, the base portion 22's side on the basis of a part of the shape 20, which is adhered to the monofilament 30, is cut and removed. For example, as shown in the drawing, a part below the monofilament 30 is removed by cutting along line C-C.

When the part below the monofilament 30 is removed from FIG. 6, artificial eyelashes 40 are obtained as shown in FIG. 7. That is, the artificial eyelashes 40, which includes the strands 21 of eyelashes formed at one time using the plastic sheet and the monofilament 30 supporting the strands 21 of eyelashes, are obtained through the above-described process.

Here, in order to curl the plurality of strands 21 like real eyelashes, as shown in FIG. 8, the artificial eyelashes 40 are rolled around a direction, in which the plurality of strands are arranged, such that the plurality of strands 21 are bent and then remain in a state for a certain amount of time. To this end, as shown in the drawing, the artificial eyelashes 40 may be rolled around a cylindrical core.

FIG. 9 illustrates a shape in which the plurality of strands 21 of the artificial eyelashes 40 are curled as a result obtained by the process of FIG. 8.

Next, as shown in FIG. 10, the monofilament 30 of the artificial eyelashes 40 is modified into an arc shape such that the plurality of strands 21 face an outside of the arc. The artificial eyelashes are completely formed when an adhesive is applied to the monofilament 30 for being attached to a human body.

FIG. 11 illustrates artificial eyelashes according to a modified embodiment of FIG. 7.

As shown in FIG. 11(a), strands of eyelashes may be cut to have pointed one ends. Instead of cutting the strands of eyelashes to have pointed one ends in the cutting process, as described above the strands 21 of FIG. 4 may be processed through a polishing process to have pointed one ends as described above.

As shown in FIG. 11(b), cutting may be performed such that an end line of eyelashes has a repetitive wedge shape. It has been described above that the end line of eyelashes may be formed to have a desired shape using the laser cutter or press puncher.

As shown in FIG. 11(c), strands of eyelashes may be cut to be sparsely arranged with a certain pattern. As another example, strands of eyelashes may be cut to have different thicknesses from each other.

When the plastic sheet 10 having a corresponding area A in which a certain picture (a heart shape illustrated as an example) or letter is printed is used for forming the plurality of strands 21 in FIG. 2, artificial eyelashes having a design in which a heart shape is shown on strands of the artificial eyelashes may be manufactured as shown in FIG. 11(d).

According to the embodiments of the present invention, the shape 20 in which the plurality of strands 21 and the base portion 22 are integrally formed is cut out of the plastic sheet 10 having a certain thickness using a laser cutter or press puncher, the monofilament 30 is adhered to the shape 20, and then the base portion 22 is removed such that an existing operation of fixing strands of eyelashes to a supporting thread by making knots one by one, which is manually performed, may be replaced by an automated operation, a working time may be significantly reduced, and a width, intervals, an end line, and the like of strands of eyelashes may be formed in desirable shapes as necessary. Additionally, artificial eyelashes having a design in which a desirable pattern is shown on strands of eyelashes may be manufactured. Also, artificial eyelashes having consistent qualities and designs such as a width, intervals, an end line, and the like of strands of eyelashes may be manufactured.

The exemplary embodiments of the present invention have been described above. It can be understood by one of ordinary skill in the art that modifications may be made without departing from the essential features of the present invention. Therefore, the described embodiments should be considered in a descriptive point of view not in a limitative one. The scope of the present invention is defined by the claims not by the above description, and it should be understood that all differences within the equivalent scope thereof are included in the present invention.

What is claimed is:

1. A method of manufacturing artificial eyelashes, comprising:
forming a shape, in which a plurality of strands and a base portion connected to one end of the plurality of strands to support the plurality of strands are integrally formed, by cutting the shape out of a plastic sheet having a certain thickness;
adhering at least one monofilament to a part of the plurality of strands, which is adjacent to the base portion, across the plurality of strands;
forming artificial eyelashes by cutting and removing the base portion's side from the shape on the basis of the part adhered to the monofilament; and
bending the plurality of strands by rolling the artificial eyelashes around a direction in which the plurality of strands are arranged.

2. The method of claim 1, further comprising polishing the plurality of strands.

3. The method of claim 1, further comprising modifying the monofilament of the artificial eyelashes, of which the plurality of strands are bent, into an arc shape.

4. The method of claim 3, further comprising applying an adhesive to the monofilament modified into the arc shape.

5. The method of claim 1, wherein the forming of the shape comprises cutting the plastic sheet using a laser cutter.

6. The method of claim 5, wherein the laser cutter uses one of an ultraviolet (UV) laser, a CO2 laser, and a fiber laser.

7. The method of claim 1, wherein a material of the plastic sheet is one of polyethylene terephthalate (PET), polyethylene (PE), nylon, polyvinyl chloride (PVC), and polypropylene (PP).

8. The method of claim 1, wherein the plurality of strands has a width of 0.05 to 0.15 mm.

9. The method of claim 1, wherein the forming of the shape comprises cutting the plastic sheet using a press puncher.
